(19) United States
(12) Patent Application Publication
(10) Pub. No.: US 2025/0046286 A1
(43) Pub. Date: Feb. 6, 2025

(54) Speaker

(71) Applicants: AAC ACOUSTIC TECHNOLOGIES (SHENZHEN) CO., LTD., Shenzhen (CN); AAC Microtech (Changzhou) Co., Ltd., Changzhou City, Jiangsu Province (CN)

(72) Inventors: Hezhi Wang, Shenzhen (CN); Jie Zhang, Shenzhen (CN); Zhongyang Wang, Shenzhen (CN)

(21) Appl. No.: 17/918,924

(22) PCT Filed: Jun. 6, 2022
(86) PCT No.: PCT/CN2022/097068

§ 371 Date: Oct. 14, 2022

(30) Foreign Application Priority Data
Apr. 29, 2022 (CN) 202221033585.3

(51) Int. Cl. G10K 11/162; H04R 1/02

(52) U.S. Cl. CPC G10K 11/162; H04R 1/02

(57) ABSTRACT

The present invention provides a speaker including a chamber filled with the sound absorbing material. The chamber is also filled with expandable foam that is triggered to expand in volume to limit the movement of the sound absorbing material in the chamber. The speaker provided by the present invention improves the reliability of the filled sound absorbing material.

### FIELD OF THE PRESENT DISCLOSURE

The present invention relates to the field of electro-acoustic transducers, in particular to a speaker filled with expandable foam in a chamber filled with sound absorbing material.

### DESCRIPTION OF RELATED ART

At present, the speaker generally adopts the method of filling the sound absorbing material in the back cavity to improve the acoustic performance of the speaker. The shape of the sound absorbing material used is mainly granular shaped, which is obtained by adding adhesive molding by adsorbing particles, and the size is generally between 0.2 mm and 0.9 mm.

When the sound absorbing material is loaded into the back cavity, due to the irregular structure of the back cavity and the electrostatic effect, the sound absorbing material cannot be fully filled into the back cavity. When the speaker is working, the sound absorbing material will vibrate violently in the back cavity, causing the sound absorbing material to be broken and affecting the performance and service life of the speaker.

Relevant solutions are mentioned as follows.

1. Increase the adhesive amount in the sound absorbing material to improve the collision reliability of the sound absorbing material. However, too much adhesive can block the pores of adsorbing particles, resulting in performance loss of the sound absorbing material;

2. Fill the back cavity with a foamable buffer filler to limit the movement of the sound absorbing material. However, the buffer filler occupies an invalid volume, and when the polymer foams, it can release organic gas that affects the performance of the sound absorbing material;

3. Fill the expandable filler in the back cavity to limit the movement of the sound absorbing material. However, the expandable filler currently used also occupies an invalid volume and is in rigid contact with the sound absorbing material, which may easily cause deformation and breakage of the sound absorbing material.

Therefore, it is necessary to provide a new speaker to solve the above technical problems.

### SUMMARY OF THE PRESENT INVENTION

The purpose of the present invention is to provide a speaker that improves the reliability of the filled sound absorbing material.

For achieving the object mentioned above, the present invention provides a speaker, including a chamber filled with sound absorbing material; and an expandable foam filled in the chamber; wherein the expandable foam is configured to be triggered to expand in volume to limit the movement of the sound absorbing material in the chamber.

In addition, a volume expansion rate of the expandable foam is greater than 10%.

In addition, a porosity of the expandable foam is greater than 50%.

In addition, the expandable foam is selected from one of compressed polyurethane foam, compressed melamine foam, compressed polyolefin foam, compressed eva (ethylene-vinyl acetate copolymer) foam.

In addition, a shape of the expandable foam is at least one of granular shape, strip shape, and blocky shape.

The invention further provides a speaker, including a housing with a containment space; a speaker unit accommodated in the containment space; and a back cavity enclosed by the speaker unit and the housing; wherein the back cavity is filled with sound absorbing material and an expandable foam that can be triggered to expand in volume to limit the movement of the sound absorbing material in the back cavity.

Further, a volume expansion rate of the expandable foam is greater than 10%.

Further, a porosity of the expandable foam is greater than 50%.

Further, the expandable foam is selected from one of compressed polyurethane foam, compressed melamine foam, compressed polyolefin foam, compressed eva (ethylene-vinyl acetate copolymer) foam.

Further, a shape of the expandable foam is at least one of granular shape, strip shape, and blocky shape.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a cross-sectional view of a speaker in accordance with an embodiment of the present invention;

FIG. 2 illustrates that a back cavity of the speaker in FIG. 1 is filled with sound absorbing material and expandable foam, wherein the expandable foam is not triggered;

FIG. 3 is similar to FIG. 2 but the expandable foam in FIG. 2 is triggered;

FIG. 4 illustrates another form in which the back cavity of the speaker FIG. 1 is filled with sound absorbing material and expandable foam, wherein the expandable foam is not triggered;

FIG. 5 is similar to FIG. 4 but the expandable foam in FIG. 4 is triggered.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

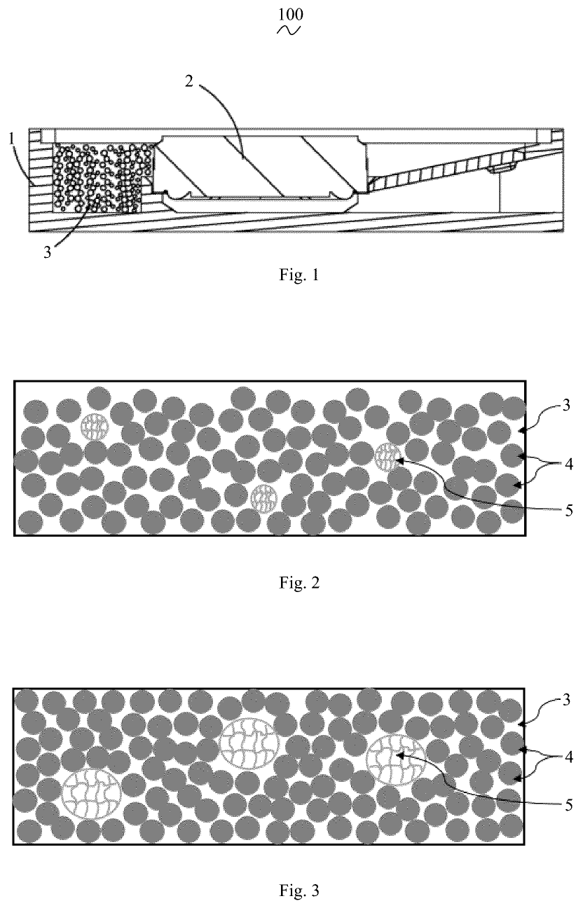

Referring to FIGS. 1-3, a speaker 100 in accordance with a first embodiment of the present invention can be applied in various types of terminals, such as mobile phones, smart watches, tablets, laptops, speakers, TVs, smart homes, cars, etc. The speaker 100 includes a housing 1 with a containment space and a speaker unit 2 contained in the containment space. The speaker unit 2 and the housing 1 enclose to form a back cavity 3, and the back cavity 3 is filled with sound absorbing material 4 and expandable foam 5.

The sound absorbing material 4 is in granular shape, which is mainly obtained by absorbing particles by adding adhesive molding, with an average size ranging from 0.2 mm to 0.9 mm. The adsorbing particles are selected from one or more of zeolite molecular sieve, activated carbon, and metal-organic frame materials. Wherein, the zeolite molecular sieve can be selected from one or more structural types such as MEL, MFI, FER, and BEA, and the skeleton structure of the zeolite molecular sieve has a molar ratio of silicon to aluminum greater than 100. The higher ratio of silicon to aluminum can ensure that the zeolite molecular sieve has a lower water absorption rate, so that the pores are not easily blocked by water vapor. The adhesive can be selected from one or more of acrylic, polyurethane and epoxy resin, and the weight percentage of adhesive is between 3% and 10%.

The expandable foam 5 is formed by compressing and fixing the foam, and has the property of re-expanding the volume after being triggered. The expandable foam 5 is preferably a polymer type foam having good elasticity and high compression recovery rate, such as at least one of the polyurethane foam, the melamine foam, the polyolefin foam, eva (ethylene-vinyl acetate copolymer) foam. The expandable foam 5 is in flexible contact with the sound absorbing material 4, and can provide a buffering effect for the sound absorbing material 4. After being triggered, the volume expansion rate of the expandable foam 5 is greater than 10%, and the higher the expansion rate, the more favorable it is to fill the back cavity 3 and better limit the movement of the sound absorbing material 4. After being triggered, the porosity of the expandable foam 5 is greater than 50%. The higher the porosity, the smaller the volume of back cavity 3 it occupies, and the smaller the impact on the acoustic performance of speaker 100. In addition, the resilience during expansion is small, and the physical structure of the sound absorbing material 4 will not be damaged. The triggering method can be physical or chemical, such as at least one of heating, UV light, and mechanical triggering. In addition, by adjusting the ratio and filling amount of the expandable foam 5 and the sound absorbing material 4, it can be controlled that the expandable foam 5 can still maintain a certain resilience after the volume expansion is triggered. When the speaker 100 is used under different conditions (such as different temperatures), the expandable foam 5 can still fully expand or contract when the sound absorbing material 4 expands or contracts due to the action of heat and cold. The sound absorbing material 4 can be effectively restricted in different usage situations.

An illustrative way of making the expandable foam 5 is as follows, the melamine foam is cut into small pieces, and the surface is impregnated with polymeric adhesive. The foam after impregnating the adhesive, and the skeletons in the compressed melamine foam are bonded and fixed to each other to become the compressed and fixed foam, namely the expandable foam 5. After being triggered by heating, when the temperature is higher than the melting point of the adhesive used, the adhesive melts and the adhesive force decreases. When the adhesive force is less than the resilience of the foam, the expandable foam 5 undergoes volume expansion. The adhesive has a melting point lower than 100° C. is preferred, and the adhesive will not release gas components that easily affect the performance of the sound absorbing material 4 under the conditions of use.

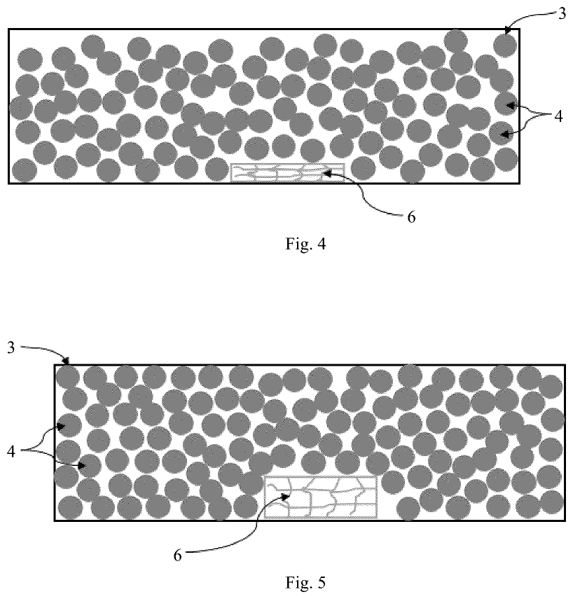

Referring to FIGS. 2-3, the expandable foam 5 in the granular shape is mixed with the sound absorbing material 4 to fill the back cavity 3. After being triggered, the volume expands to limit the movement of the sound absorbing material 4 in the back cavity 3.

Referring to FIGS. 4-5, the expandable foam 6 in the blocky shape is fixed at any position of the inner surface of the back cavity 3, and the volume expands after being triggered to limit the movement of the sound absorbing material 4 in the back cavity 3.

It should be noted that the expandable foam can be filled into the back cavity together with the sound absorbing material. Or put the expandable foam in the back cavity first and then fill with the sound absorbing material, or fill the back cavity with the sound absorbing material and then fill with the expandable foam. The order of filling has no obvious effect on the performance of the product. In addition to granular shape and blocky shape, the expandable foam can also be in strip shape or any other shape.

It should also be noted that the sound absorbing material and the expandable foam can be filled into the back cavity enclosed by the speaker unit and the housing as described above. In addition, it can also be filled into the chamber of the sound absorbing element placed in the speaker, or into the partitioned part of the chamber in the speaker, or even into the front cavity of the speaker. In other words, as long as the speaker needs to apply the sound absorbing material, and the chamber filled with sound absorbing material can be filled with the expandable foam, this belongs to the content of the present invention.

In the speaker provided by the present invention, the chamber filled with the sound absorbing material is filled with the expandable foam, and the expandable foam expands in volume after being triggered to limit the movement of the sound absorbing material in the chamber. At the same time, the expandable foam and the sound absorbing material are in flexible contact, which can provide a buffering effect for the sound absorbing material and improve the reliability of the filled sound absorbing material.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker, including:
a chamber filled with sound absorbing material; and
an expandable foam filled in the chamber; wherein
the expandable foam is configured to be triggered to expand in volume to limit the movement of the sound absorbing material in the chamber.

2. The speaker as described in claim 1, wherein, a volume expansion rate of the expandable foam is greater than 10%.

3. The speaker as described in claim 1, wherein a porosity of the expandable foam is greater than 50%.

4. The speaker as described in claim 1, wherein the expandable foam is selected from one of compressed polyurethane foam, compressed melamine foam, compressed polyolefin foam, compressed eva (ethylene-vinyl acetate copolymer) foam.

5. The speaker as described in claim 1, wherein a shape of the expandable foam is at least one of granular shape, strip shape, and blocky shape.

6. A speaker, including:
a housing with a containment space;
a speaker unit accommodated in the containment space;
a back cavity enclosed by the speaker unit and the housing; wherein
the back cavity is filled with sound absorbing material and an expandable foam that can be triggered to expand in volume to limit the movement of the sound absorbing material in the back cavity.

7. The speaker as described in claim 6, wherein, a volume expansion rate of the expandable foam is greater than 10%.

8. The speaker as described in claim 6, wherein a porosity of the expandable foam is greater than 50%.

9. The speaker as described in claim 6, wherein the expandable foam is selected from one of compressed polyurethane foam, compressed melamine foam, compressed polyolefin foam, compressed eva (ethylene-vinyl acetate copolymer) foam.

10. The speaker as described in claim 6, wherein a shape of the expandable foam is at least one of granular shape, strip shape, and blocky shape.
